(19) United States
(12) Patent Application Publication
(10) Pub. No.: US 2023/0139988 A1
(43) Pub. Date: May 4, 2023

(54) EFFICIENT SCAN THROUGH COMPREHENSIVE BITMAP-INDEX OVER COLUMNAR STORAGE FORMAT

(71) Applicant: ALIBABA GROUP HOLDING LIMITED, George Town, Grand Cayman (KY)

(72) Inventors: Jihong MA, Saratoga, CA (US); Shuai XU, San Diego, CA (US); Xiaowei JIANG, Bellevue, WA (US)

(21) Appl. No.: 17/310,079

(22) PCT Filed: Jul. 24, 2020
(86) PCT No.: PCT/CN2020/104515

§ 371 Date: Jul. 15, 2021

(51) Int. Cl. G06F 16/22

(52) U.S. Cl. CPC G06F 16/221; G06F 16/2237

(57) ABSTRACT

The present disclosure provides systems and methods for executing a query in a data analytics storage engine. An example method comprising: receiving a query to locate target data in the data analytics storage engine that comprises: rows of data divided into one or more splits of data having columns of data that correspond to the rows of data, and bitmap data embedded in the one or more splits, wherein the bitmap data is associated with the columns of data; and locating the target data using the bitmap data in the one or more splits.

### CROSS-REFERENCE TO RELATED PATENT APPLICATIONS

This application is a national stage filing under 35 U.S.C. § 371 of International Application No. PCT/CN2020/104515, filed on Jul. 24, 2020, the contents of which are incorporated herein by reference in its entirety.

### TECHNICAL FIELD

The present disclosure generally relates to columnar store indexing, and more particularly, to bitmap indexing in large scale distributed data analytics storage engine.

### BACKGROUND

Big data technology has allowed for processing of massive volume of data including real-time data, which is unlocking potentials in making real-time business decision via large scale distributed big data analytics. Open source columnar storage formats (e.g., Apache Parquet, Apache ORC) for distributed data query processing engine have been developed to allow for efficient analysis of the underlying data through wide variety of SQL query processing. However, these columnar storage format often suffer from a significant drawback in that they do not have a comprehensive embedded indexing structure in place that can provide effective predicate pushdown to scan only data that qualifies filter predicates.

### SUMMARY

Embodiments of the present disclosure provides a method for executing a SQL query in data analytics storage engine, the method comprising: receiving a query to scan relevant data that matches in the columnar store that comprises: rows of data divided into one or more file splits, each file split is stored in columnar fashion, wherein the bitmap index associated with its corresponding column are embedded along with column data for each file splits, which are leveraged at query processing time to effectively skip those portion of data that doesn't qualify the filter predicate, in turn to achieve efficient scan & dramatically reduce I/O cost.

Moreover, embodiments of the present disclosure provide a data analytics storage engine. The data analytics storage engine comprises: rows of data divided into one or more splits of data having columns of data that correspond to the rows of data, and bitmap data embedded in the one or more splits, wherein the bitmap data is associated with the columns of data and the bitmap data is configured to locate, in the one or more splits, target data in a query.

Moreover, embodiments of the present disclosure also provide non-transitory computer readable media that store a set of instructions that is executable by one or more processors of a data analytics storage engine to cause the data analytics storage engine to initiate a method comprising: receiving a query to locate target data in the data analytics storage engine that comprises: rows of data divided into one or more splits of data having columns of data that correspond to the rows of data, and bitmap data embedded in the one or more splits, wherein the bitmap data is associated with the columns of data; and locating the target data using the bitmap data in the one or more splits.

### BRIEF DESCRIPTION OF THE DRAWINGS

The accompanying drawings, which are incorporated in and constitute a part of this specification, illustrate embodiments consistent with the invention and, together with the description, explain the principles of the invention.

FIG. 1A illustrates an example format of storing row data in a row-based storage.

FIG. 1B illustrates an example format of storing columnar data in a columnar storage.

FIG. 1C illustrates an example format of storing continuous columnar data in columnar storage.

FIG. 2 illustrates an example format of splits in columnar storage.

FIG. 3 illustrates an example scan operation in a data analytics storage engine.

FIG. 4 illustrates a schematic diagram of an example server of data analytics storage engine, according to some embodiments of the present disclosure.

FIG. 5 illustrates an example columnar data chunk, according to some embodiments of the present disclosure.

FIG. 6 illustrates an example split with embedded bitmap data, according to some embodiments of the disclosure.

FIG. 7 illustrates an example split with embedded bitmap data and embedded dictionary data, according to some embodiments of the present disclosure.

FIG. 8 illustrates an example process to execute a query using embedded dictionary data and bitmap data, according to some embodiments of the present disclosure.

FIG. 9 illustrates a flowchart of an exemplary method for executing a query using embedded bitmap data in splits, according to some embodiments of the present disclosure.

FIG. 10 illustrates a flowchart of an exemplary method for executing a query using embedded bitmap data and dictionary data, according to some embodiments of the present disclosure.

FIG. 11 illustrates a flowchart of an exemplary method for executing a query using embedded bitmap data and dictionary data, according to some embodiments of the disclosure.

FIG. 12 illustrates an example process to execute a query using embedded dictionary data, bitmap data and bitmap index data, according to some embodiments of the present disclosure.

FIG. 13 illustrates a flowchart of an exemplary method for executing a query using embedded bitmap data, dictionary data, and bitmap index, according to some embodiments of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

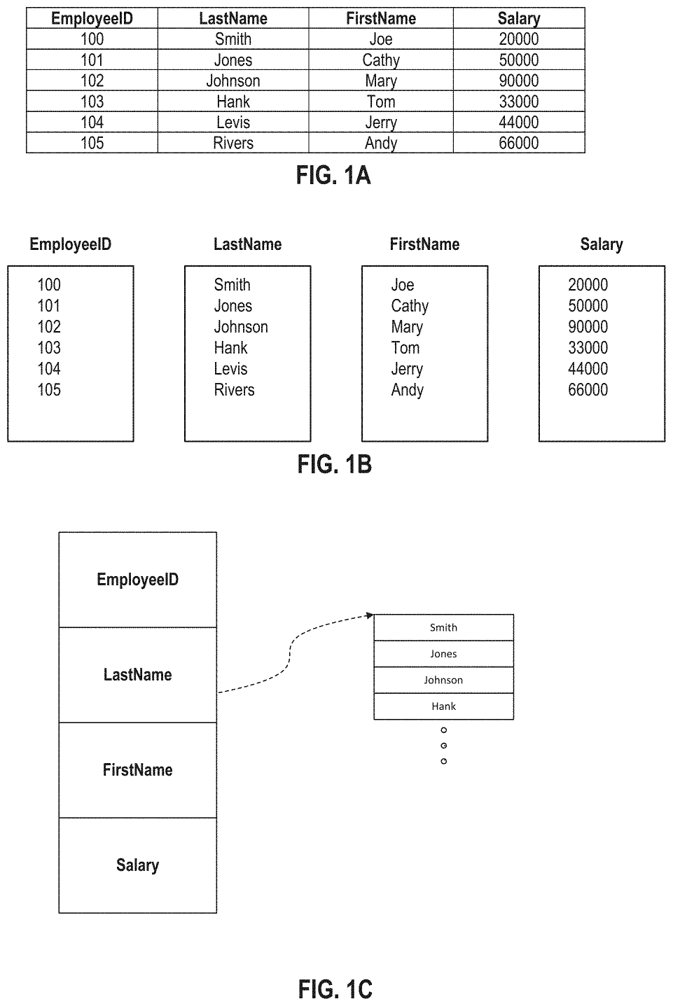

Many of the modern data analytics storage engines or databases store data in columnar fashion rather than in a row-based fashion. FIG. 1A illustrates an example format of storing row data in a row-based storage. As illustrated in FIG. 1A, data can be logically represented as a two-dimensional table, which comprises columns and rows. The table shown in FIG. 1A has four columns and six rows. The columns are named “EmployeeID,” “LastName,” “FirstName,” and “Salary.” Data shown in the table can be stored in a number of ways. One way is called row-oriented storage. In row-oriented storage, data is stored row by row, and all the columns of a single row are physically placed together, similar to those shown in FIG. 1A. The row-oriented storage is used for efficient access of data located in the same row. For example, if a user of a data analytics storage engine system wishes to retrieve all column information associated with an entry “100” in the “EmployeeID” column, the user can easily retrieve entries “Smith,” “Joe,” and “20000” from the storage since these entries are physically stored together. Row-oriented storage is commonly used for transactional queries, such as online transactional processing (“OLTP”).

Another way to store data is called column-oriented storage. In column-oriented storage, data is stored column by column, and all the rows of a single column are physically placed together. FIG. 1B illustrates an example format of storing columnar data in a columnar storage. As shown in FIG. 1B, each column is stored separately. For example, all entries in the “EmployeeID” column are stored together. Sometimes, each column is usually further divided into blocks and each block is stored in compressed form. During query processing, data is read back from storage into memory in units of blocks.

In some implementations, the columns can be stored together in order. FIG. 1C illustrates an example format of storing continuous columnar data in a columnar storage. As shown in FIG. 1C, each column is stored one after the other in order. For example, in the same order that is presented in FIG. 1A, columns in FIG. 1C are stored in the order of “EmployeeID,” “LastName,” “FirstName,” and “Salary.”

The column-oriented storage is used to efficiently support analytical queries that are often interested in a subset of one or more columns. With the column-oriented storage, data of a particular column or a few columns can be retrieved without wasting input/output (“I/O”) bandwidth on columns that are not needed. In addition, column-oriented storage can allow for more efficient data compression because data in a column is typically of a same type. Column-orientated storage has demonstrated an ability to provide significant saving on I/O cost for many analytical queries, specifically online analytical processing (“OLAP”).

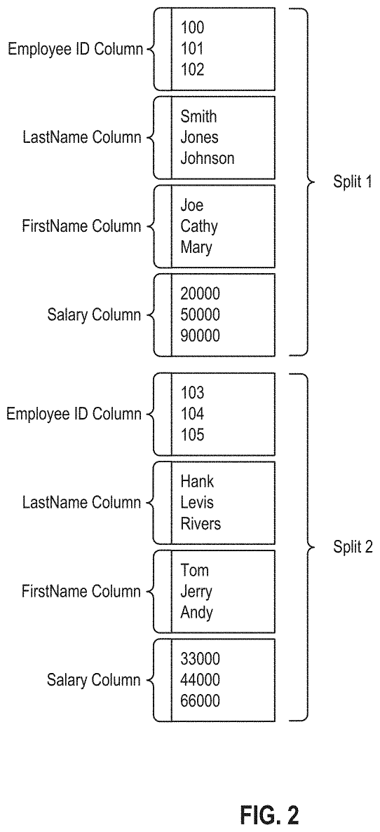

To allow for better parallelism of scanning columnar storage, some columnar storage adopted file splits or row-column hybrid storage. It first divides rows into file splits, which can also be further divided into row groups. A file split can comprise complete set of rows for each column. The column-oriented storage is then used for each split. FIG. 2 illustrates an example format of splits in column storage. Using the data illustrated in FIGS. 1A-1C as an example, the row-group columnar storage of FIG. 2 divides up the data into two splits named split 1 and split 2. Split 1 comprises the first three rows of data, and split 2 comprises the next three rows of data. Data in each row group is then stored according to the column-oriented storage.

The split level columnar storage gets a great deal of benefit of the column-oriented storage that is applied to each file split, because data inside each split is still stored in a column-oriented storage. In the following description, column-oriented storage is used to describe pure column-oriented storage and its row-column variant, and split level columnar storage and row-column hybrid storage are used interchangeably.

Indexing is a data structure technique that can accelerate processing of queries in a data analytics storage engine. An index can map values within one or more columns of a data analytics storage engine table to the “EmployeeID” values of rows that have the corresponding values on the column(s). Indexing allows for fast lookup of rows with a given column value(s). Many of the major data analytics storage engines can support certain types of indexing. For example, B-Tree and bitmap indices are widely supported in many popular data analytics storage engines.

To support indexing on a data analytics storage engine table, each row in a data analytics storage engine table can have a unique row number as its identifier. One of the most logical way to assign row numbers is to number each row from the start of a file split and move downwards.

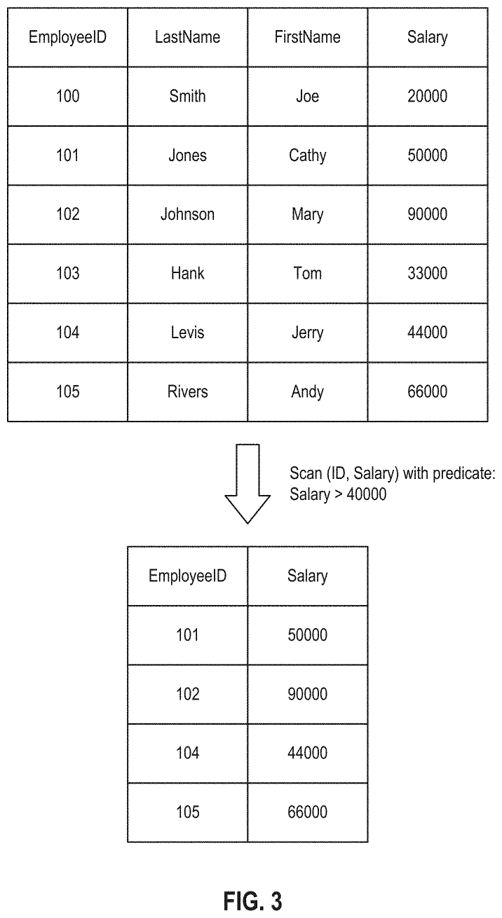

A scan operation is a primitive operation in SQL queries. A scan operation takes as input a table, and optionally a set of projected columns and a set of predicates, and outputs a set of projected rows in a table that satisfies the given predicates. A predicate can be a conditional expression that evaluates to a Boolean value. For example, in SQL queries, predicates can be encountered in a “where” clause, and can be used to filter data. FIG. 3 illustrates an example scan operation in a data analytics storage engine. According to FIG. 3, the scan has a predicate “Salary>40000” and a projection of (EmployeeID, Salary). To perform the scan operation, each row of the table is examined to check if the row satisfies the predicate. If the row satisfies, the selected columns in the projection is outputted. For example, the salary column in the second row reads 50000, which satisfies the “Salary>40000” predicate. As a result, (101, 50000) is outputted. Data in the selected columns can also be referred to as target data for the query.

Sometimes, parts of the predicates can be “pushed down” to where the data is stored. This optimization can drastically reduce the processing time of the queries by filtering out data earlier rather than later. Depending on the processing framework, predicate pushdown can optimize queries by filtering data before the data is transferred over the network or loaded into memory. Predicate pushdown can also reduce the processing time by skipping reading entire data files or data chunks.

Min-max index can be a part of indexing that provide statistical information of value ranges for columns. The min-max index can be used for columns in different chunks of data at a file level, a split level, a row-group level, etc. For a given predicate, the min-max index can be used to skip a portion of data files, since the min-max index can allow the data analytics storage engine to evaluate if the predicate inquires on values within the min-max range for a specific column.

A bloom filter is a space-efficient probabilistic data structure that is used to test whether an element is a member of a set. For a given set, a bloom filter can indicate whether a value is definitely not in the set, or may be in the set. As a result, false positive matches are possible in bloom filters, while false negatives are not. The bloom filter can facilitate predicates by quickly pointing out whether a given key can be found in a column with a relatively high accuracy. As a result, the data system can quickly determine whether a portion of a column contains the given key and skip most of the columns that are determined to not contain the given key.

As shown in FIG. 2, the columnar storage format has been used in big data ecosystems. One of the advantages of the columnar storage format is efficient encoding and compression processing at the column level. In addition, the columnar storage format is advantageous for sequential scanning during query processing. For example, the min-max index and the bloom filters can help indicating if certain values are stored in a data block without spending much time and resources to read the data block. However, the min-max index may not always be effective. For example, if a column is not sorted, the min-max index for different portions of the column can overlap, forcing the data analytics storage engine to read many more irrelevant data blocks that are later eliminated as they do not satisfy the filter predicate. Moreover, the bloom filter is designed to be suitable for queries with equal predicate, but its effectiveness relies heavily on the false positive rate associated with the probabilistic data structure. Therefore, if the false positive rate is high, scan skipping effectiveness would suffer.

To compensate for these disadvantages, many of the traditional data analytics storage engine systems have leveraged bitmap index as a secondary index. The bitmap index can be used to answer queries by performing bitwise logical operations on the bitwise data stored in the bitmap for a column. Bitmap indexes have traditionally been considered to work well for low-cardinality columns, which have a modest number of distinct values. An extreme case of low cardinality is Boolean data, which has only two distinct values (e.g., True or False). The bitmap index is very effective in improving query performance in data analytics storage engines. For example, the bitmap index can provide fast access to equal predicate pattern matching (e.g., predicates that include equal literal values).

In addition to the bitmap index, dictionary data can also be used. Dictionary data can comprise distinct values of a corresponding column, and inherit the data type of the corresponding column. For example, if a column of data includes values of a string type, the corresponding dictionary data can also be constructed using the string data type. Moreover, the column of data may comprise multiple entries with the value “Smith.” As a result, the corresponding dictionary data can include only one value of “Smith,” since the dictionary data may only include distinct values in the corresponding column.

There are several issues with the current design of bitmap index. For columns with a relatively higher cardinality, significantly more resources (e.g., storage resources) are needed to maintain the bitmap index. This is because the bitmap index cannot be compressed efficiently. As a result, the bitmap index can require significant memory space to store. When the bitmap index is used, the data analytics storage engine system needs to load the bitmap index from a physical storage into memory, causing significant I/O overhead. If a data analytics storage engine system performs frequent data updates (e.g., data insertion and data deletion), the associated bitmap index is also loaded frequently, adding even more strains on the system. Therefore, bitmap indexes are only well-suited for read-only tables or tables that have infrequent updates.

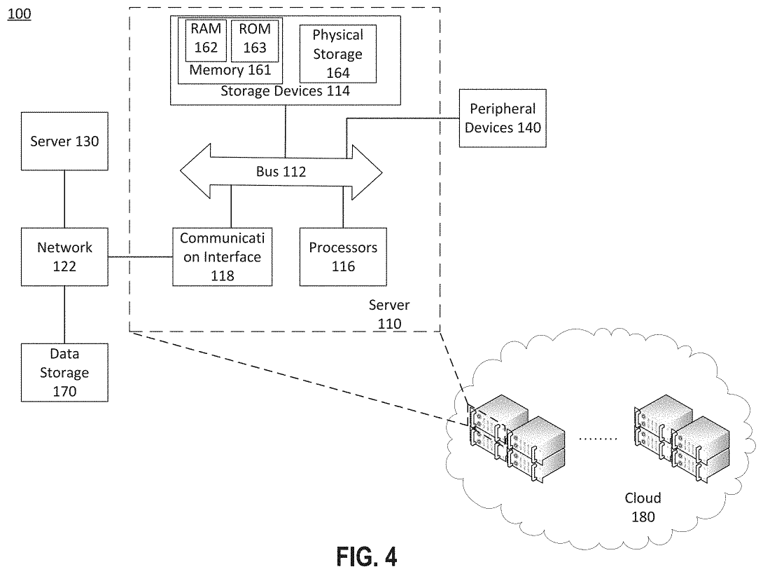

To solve these issues, embodiments of the present disclosure provide embedded bitmap index support to columnar storage format. FIG. 4 illustrates a schematic diagram of a data analytic engine, according to some embodiments of the present disclosure. According to FIG. 4, cloud 180 comprises one or more servers, including server 110 of data analytic engine 100. Server 110 comprises a bus 112 or other communication mechanism for communicating information, and one or more processors 116 communicatively coupled with bus 112 for processing information. Processors 116 can be, for example, one or more microprocessors. In some embodiments, data analytics storage engine can be deployed using a docker.

Server 110 can transmit data to or communicate with another server 130 through a network 122. Network 122 can be a local network, an internet service provider, internet, or any combination thereof. Communication interface 118 of server 110 is connected to network 122. In addition, server 110 can be coupled via bus 112 to peripheral devices 140, which comprises displays (e.g., cathode ray tube (CRT), liquid crystal display (LCD), touch screen, etc.) and input devices (e.g., keyboard, mouse, soft keypad, etc.).

Server 110 can be implemented using customized hard-wired logic, one or more ASICs or FPGAs, firmware, or program logic that in combination with the server causes server 110 to be a special-purpose machine.

Server 110 further comprises storage devices 114, which may include memory 161 and physical storage 164 (e.g., hard drive, solid-state drive, etc.). Memory 161 may include random access memory (RAM) 162 and read only memory (ROM) 163. Storage devices 114 can be communicatively coupled with processors 116 via bus 112. Storage devices 114 may include a main memory, which can be used for storing temporary variables or other intermediate information during execution of instructions to be executed by processors 116. Such instructions, after being stored in non-transitory storage media accessible to processors 116, render server 110 into a special-purpose machine that is customized to perform operations specified in the instructions. The term “non-transitory media” as used herein refers to any non-transitory media storing data or instructions that cause a machine to operate in a specific fashion. Such non-transitory media can comprise non-volatile media or volatile media. Non-transitory media include, for example, optical or magnetic disks, dynamic memory, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, flash memory, register, cache, any other memory chip or cartridge, and networked versions of the same.

Various forms of media can be involved in carrying one or more sequences of one or more instructions to processors 116 for execution. For example, the instructions can initially be carried out on a magnetic disk or solid-state drive of a remote computer. The remote computer can load the instructions into its dynamic memory and send the instructions over a telephone line using a modem. A modem local to server 110 can receive the data on the telephone line and use an infra-red transmitter to convert the data to an infra-red signal. An infra-red detector can receive the data carried in the infra-red signal and appropriate circuitry can place the data on bus 112. Bus 112 carries the data to the main memory within storage devices 114, from which processors 116 retrieves and executes the instructions.

In data analytics storage engine, data can be stored in data storage 170, which can be accessed by servers (e.g., server 110 or server 130) via network 122. In some embodiments, data can be stored in storage devices 114 or physical storage 164 of server 110 or server 130. In some embodiments, data is stored in a separate entity from the servers. For example, as shown in FIG. 4, data can be stored in data storage 170, which is separate from the servers (e.g., server 110 or server 130).

In some embodiments, the bitmap index can be stored along with the associated data in the data file. The embedded bitmap index design can provide many advantages. First, the maintenance cost for storing and using the bitmap index is very low. This is because the data file is immutable. For example, columnar data files are generally stored in cloud storage or distributed file systems, which give the columnar data files the immutable property. As a result, when data gets updated (e.g., data insertion or data deletion), no special handling is needed for maintaining the bitmap index. A separate delete index can be created to handle data updates. Second, a mapping between the columnar or the row-group columnar data and the corresponding bitmap index can be conveniently established when they are stored close to each other. Therefore, additional index metadata and file management data can be eliminated. Third, split files can be read in parallel. As a result, the bitmap index embedded in the split files can also be read or analyzed in parallel, making the system more efficient in executing queries.

In general, columnar storage format in big data ecosystem in general includes one or more splits. A split can be a group of rows for all columns. In some embodiments, splits can be treated as a unit for parallel reading. A split can include column chunk data and column index data. Column chunk data can comprise a column chunk for each column, and the column chunks can be contiguous. For example, a column chunk can be continuously compressed data blocks for one column, and a column chunk can be followed by another column chunk for all columns as data is stored in columnar fashion. Using the data analytics storage engine in FIG. 2 as an example, row group 1 can be a column chunk data, which comprises 4 column chunks for each of the columns “EmployeeID,” “LastName,” “FirstName,” and “Salary.” In addition to splits, columnar files also include a split footer and a file footer, usually at the end of the columnar file.

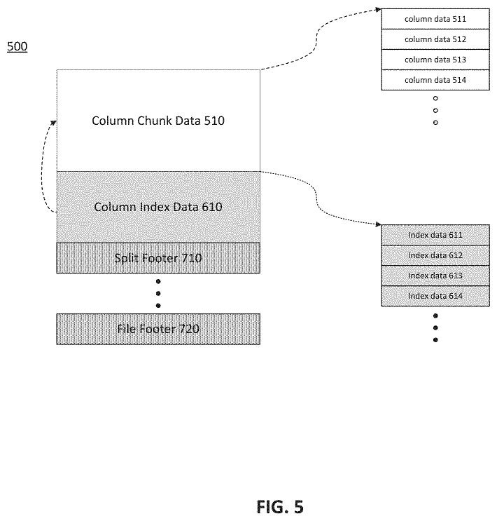

FIG. 5 illustrates an example columnar data chunk, according to some embodiments of the present disclosure. As shown in FIG. 5, a split 500 can include column chunk data 510. Column chunk data 510 can comprise one or more compressed column data chunks, such as column data 511, 512, 513, and 514. In some embodiments, column data 511, 512, 513 and 514 can be stored in order. For example, referring back to FIGS. 1A-1C, columns “EmployeeID,” “LastName,” “First Name,” and “Salary” can be stored in order. As a result, column “EmployeeID” can be FIG. 5's column data 511, column “LastName” can be FIG. 5's column data 512, column “First Name” can be FIG. 5's column data 513, and column “Salary” can be FIG. 5's column data 514. As shown in FIG. 5, column data 511, 512, 513, and 514 are stored in order, just like columns “EmployeeID,” “LastName,” “First Name,” and “Salary” shown in FIG. 1C.

Split 500 can also comprise column index data 610 (shown in grey on FIG. 5). In some embodiments, column data for each column is written into storage first, followed by the column index data for each corresponding column. Column index data 610 can comprise index data for the column data stored in column chunk data 510. For example, Column index data 610 can comprise index data for column data 511, 512, 513, 514, etc. In some embodiments, column data (e.g., column data 511, 512, 513, and 514) can comprise one or more row groups, and each row group's index data (e.g., position of the row group, min-max index of the row group, etc.) can be stored in column index data 610. In some embodiments, the index data stored in column index data 610 is in the same order as the column data in column chunk data 510. For example, as shown in FIG. 5, column index data 610 can comprise index data 611, 612, 613, and 614, which are stored in order. Index data 611 can correspond to column data 511. Index data 612 can correspond to column data 512. Index data 613 can correspond to column data 513. And index data 614 can correspond to column data 514.

In some embodiments, column index data can include one or more types of index for a logical row group (e.g., per 8,000 rows). The column index data can include min-max statistics or bloom filter entry for each row-group. They can form the min-max index and the bloom filter index for a split. For example, column index data 610 can comprise min-max index for column chunk data 510. More specifically, index data 614 can comprise min-max index for a column stored in column data 514. Using the tables in FIGS. 1A-1C as an example, column data 514 can comprise column “Salary,” and index data 614 can comprise min-max index for column “Salary,” with a minimum value being “20000” and a maximum value being “90000.”

In some embodiments, a split can also comprise a split footer. For example, split 500 in FIG. 5 can also comprise split footer 710. A file footer 720 can be included at the end after the last file split of a columnar file.

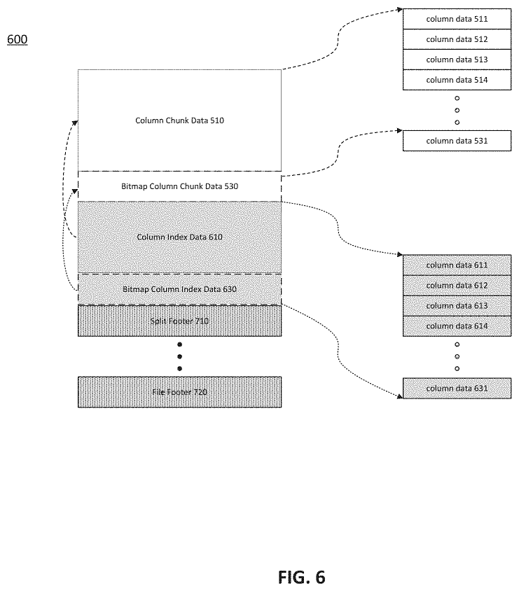

In some embodiments, embedded bitmap index can be stored as an embedded table. FIG. 6 illustrates an example split with embedded bitmap data, according to some embodiments of the present disclosure. Similar to split 500 shown in FIG. 5, split 600 shown in FIG. 6 can also comprise column chunk data 510, column index data 610, split footer 710, and file footer 720. In addition, split 600 comprises bitmap column chunk data 530. In some embodiments, bitmap column chunk data 530 corresponds to column chunk data 510. For example, bitmap column chunk data 530 comprises bitmap index for column data (e.g., column data 511, 512, 513, 514, etc.) stored in column chunk data 510. In some embodiments, there is a one-to-one mapping between a column within a split and the column's corresponding bitmap index data. For example, column col1 can have a corresponding embedded bitmap index data, and column col2 can have a corresponding embedded bitmap index data that is separate from col1's embedded bitmap index data. In some embodiments, bitmap column chunk data 530 can be stored close to column chunk data 510. For example, bitmap column chunk data 530 can be stored right before or after column chunk data 510. In some embodiments, a column of data can be stored close to the column's corresponding embedded bitmap index data. Storing the column of data together with the column's corresponding bitmap index data can provide more efficient data processing, since the system can make traversing between the column of data and the bitmap index data more efficient.

In some embodiments, split 600 can comprise bitmap column index data 630. Bitmap column index data 630 can correspond to bitmap column chunk data 530. For example, bitmap column index data 630 can comprise min-max index for bitmap column chunk data 530. In some embodiments, bitmap column index data 630 can be stored close to column index data 610. For example, bitmap column index data 630 can be stored right before or after column index data 610.

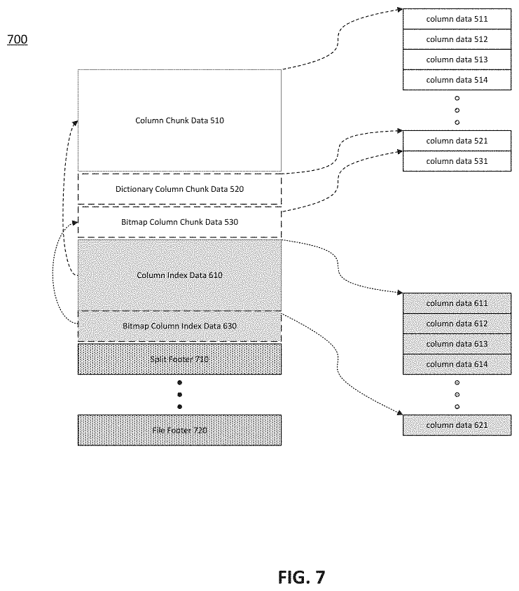

In some embodiments, the embedded table can include two types of index, such as dictionary data and bitmap data. FIG. 7 illustrates an example split with embedded bitmap data and embedded dictionary data, according to some embodiments of the present disclosure. Similar to split 500 shown in FIG. 5 and split 600 shown in FIG. 6, split 700 shown in FIG. 7 can also comprise column chunk data 510, column index data 610, split footer 710, or file footer 720. Similar to split 600 shown in FIG. 6, split 700 can further comprise bitmap column chunk data 530 and bitmap column index data 630. In addition, split 700 can comprise dictionary column chunk data 520. In some embodiments, a dictionary column (e.g., column data 531) stored in dictionary column chunk data 520 can include all distinct values for the corresponding column data. In some embodiments, a dictionary column can inherit the data type of the corresponding column data and preserve orderings of the corresponding column data. In some embodiments, a bitmap column (e.g., column data 521) stored in bitmap column chunk data 530 can include bitmaps for one or more values in the corresponding dictionary column (e.g., dictionary column in the same embedded table). In some embodiments, a bitmap column can be stored as a binary column. In some embodiments, dictionary column chunk data 520 can be searched (e.g., linear search or binary search). It is appreciated that column chunk data 510, dictionary column chunk data 520, bitmap column chunk data 530, column index data 610, and bitmap column index data 630 can be stored in any order.

In some embodiments, a bitmap index (e.g., bitmap column chunk data 530 shown in FIG. 6 and FIG. 7) can be a Roaring bitmap. A Roaring bitmap can be compressed bitmaps that divide data into chunks of integers (e.g., [0, 2¹⁶), [2¹⁶, 2×2¹⁶), etc.). Within a chunk, it can use an uncompressed bitmap, a simple list of integers, or a list of runs. Whatever format the Roaring bitmap uses, the Roaring bitmap allows for checking for the presence of a value quickly (e.g., with a binary search). The net result is that Roaring can compute many operations much faster than run-length-encoded formats (e.g., Word Aligned Hybrid compression scheme (“WAH”), Enhanced World Aligned Hybrid compression scheme (“EWAH”), Concise, etc.) In addition, Roaring bitmap can also offer better compression ratios.

As shown in FIG. 7, the bitmap index can be embedded along with the columnar data itself in a columnar data file or a row-group columnar file. In some embodiments, a column can also have a dictionary that includes all distinct values. With the help of the dictionary, the data analytics storage engine system can load only the corresponding bitmap for a specific key so that only a portion of a data file that includes matching records are scanned. Another advantage of using the embedded bitmap index is an ability to answer queries by performing bitwise logical operations on bitmaps. It has shown significant space and performance efficiency over other index structures.

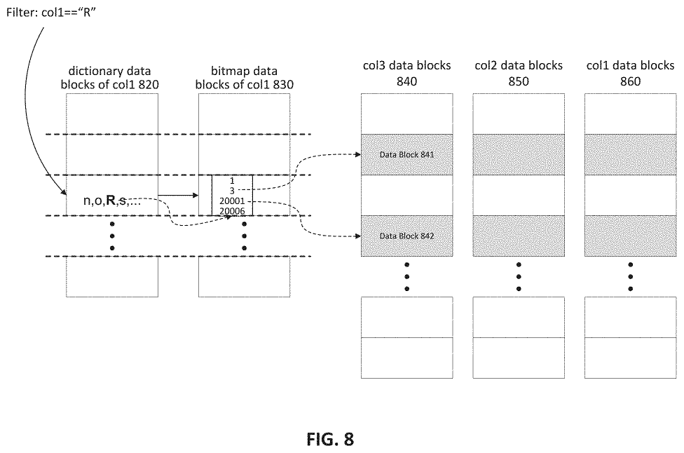

FIG. 8 illustrates an example process to execute a query using embedded dictionary data and bitmap data, according to some embodiments of the present disclosure. As shown in FIG. 8, an example query to be executed is “select sum(col3) from table1 where col1=‘R’.” In other words, the query selects rows where the value in column col1 is equal to “R,” and finds the sum of all values in column col3 for the selected rows. It is appreciated that any query that aims to find specific target data in the data analytics storage engine can be executed using the process shown in FIG. 8. For example, the target data in query “select sum(col3) from table1 where col1=‘R’” is data in column col3 where the value in column 1 is equal to “R.” It is appreciated that the process shown in FIG. 8 can be performed by a data analytics storage engine system (e.g., data analytics storage engine system 100 of FIG. 4) or a server (e.g., server 110 of FIG. 4).

To select rows where “col1=‘R’,” the data analytics storage engine system executing the query can load dictionary column data 520 shown in FIG. 7. When executing the query, the data analytics storage engine system can scan dictionary column data 620 (e.g., sequential scan or binary search) and locate the predicate to find out its corresponding encoding value (e.g., col1=“R”). In some embodiments, dictionary column data 620 is scanned to find mapping information for the predicate and the corresponding encoding value.

In some embodiments, since the dictionary column includes distinct values, there is only one value of “R” in the dictionary data blocks. In some embodiments, dictionary column 810 is sorted and order preserving. As a result, a binary search can be conducted on dictionary column 810 to find an entry including the distinct value “R.”

As shown in FIG. 8, blocks in the dictionary data blocks of col1 820 can include location information for the corresponding blocks in bitmap data blocks of col1 830. In other words, blocks in the dictionary data blocks of col1 820 can include mappings between a predicate value (e.g., “R” in column col1) and a corresponding block in the bitmap data blocks of col1 830. For example, the third entry in dictionary data blocks of col1 820 can comprise a pointer that points to a corresponding block in the bitmap data blocks of col1 830 (e.g., the third block in bitmap data blocks of col1 830). In some embodiments, the mappings between a predicate value and a corresponding block and offset within the block in the bitmap data can be established based on the encoding value of the distinct value in the dictionary column (e.g., value “R” in column col1). In some embodiments, entries in the block of dictionary data blocks of col1 820 can also comprise an offset. For example, value “R” in the third block can comprise an offset (e.g., value 3) indicating the relative position of value “R” in the block. This offset can be used to locate the entry in the corresponding bitmap data block (e.g., the third entry in the corresponding bitmap data block). In the example shown in FIG. 8, the entry that includes value “R” has an offset that points to the entry in the bitmap data block that includes values “1,” “3,” “20001,” “20006,” etc. In some embodiments, instead of an offset, the values in the block of dictionary data blocks of col1 820 can comprise a pointer that locates the corresponding entry in the corresponding bitmap data block.

As described above, there can be a mapping relationship between dictionary data blocks of col1 820 and bitmap data blocks of col1 830. This mapping relationship can allow the data analytics storage engine system to quickly locate the relevant entry in the bitmap data blocks of col1 830 that satisfies the predicate (e.g., col1=“R”). As a result, the data analytics storage engine system does not have to load and access irrelevant blocks in the bitmap data blocks of col1 830. Moreover, the data analytics storage engine system does not have to load and access irrelevant entries in the corresponding bitmap data block (e.g., the third block of bitmap data blocks of col1 830). As a result, the data analytics storage engine system can speed up the query execution and preserve valuable I/O resources while executing the query.

As shown in FIG. 8, when the entry in the bitmap data blocks of col1 830 is determined according to the predicate (e.g., col1=“R”), this entry can be loaded into memory and accessed, and a bitwise operation can be performed on the values stored in the entry to determine locations of data blocks that include relevant data for the query (e.g., data stored in column col3). For example, a bitwise operation can be conducted on value “3” stored in the entry to determine the location of data block 841. Data block 841 can include data in column col3 where the corresponding row satisfies the predicate (e.g., col1=“R”). Similarly, a bitwise operation can be conducted on value “20001” in the entry to determine the location of data block 842. As a result, only relevant data blocks in the split are to be accessed by the data analytics storage engine system. The data analytics storage engine system can ignore irrelevant blocks in col3 data blocks 840. Further, in some embodiments, the data analytics storage engine system can ignore all blocks in col2 data blocks 850 and col1 data blocks 860.

In some embodiments, the bitmap in FIG. 8 can be a Roaring bitmap. A Roaring bitmap can divide bit entries into chunks of integers (e.g., [0, 2¹⁶), [2¹⁶, 2×2¹⁶), etc.). Within a chunk, it can use an uncompressed bitmap, a simple list of integers, or a list of runs. Whatever format it uses, they all allow for checking for the presence of any one value quickly (e.g., with a binary search). The net result is that Roaring bitmap can compute many operations much faster than run-length-encoded formats (e.g., Word Aligned Hybrid compression scheme (“WAH”), Enhanced World Aligned Hybrid compression scheme (“EWAH”), Concise, etc.) In addition, Roaring bitmap can also offer better compression ratios.

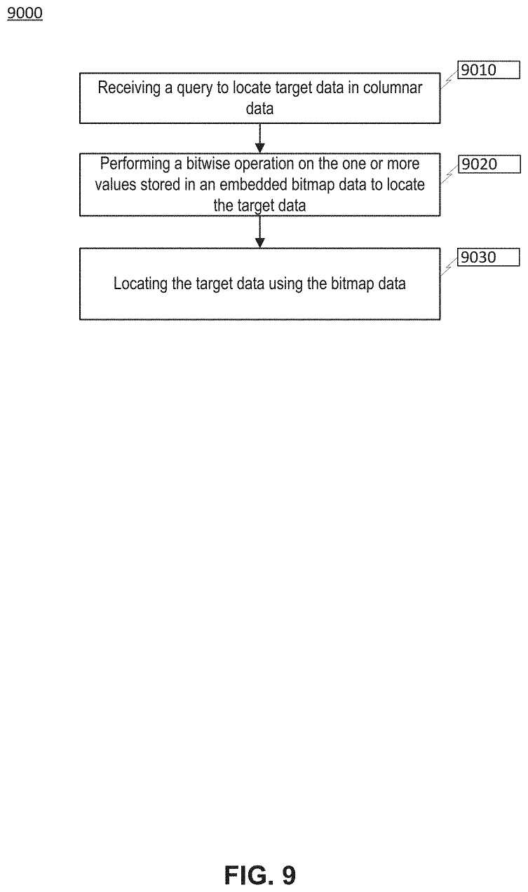

Embodiments of the present disclosure provides a method to perform a query using embedded bitmap data in splits. FIG. 9 illustrates a flowchart of an exemplary method for executing a query using embedded bitmap data in splits, according to some embodiments of the disclosure. It is appreciated that method 9000 of FIG. 9 may be performed by a data analytics storage engine system (e.g., data analytics storage engine system 100 of FIG. 4) or a server (e.g., server 110 of FIG. 4). It is also appreciated that method 9000 of FIG. 9 can operate on data analytics storage engines that use embedded bitmap data (e.g., bitmap column chunk data 530 of FIG. 6 and FIG. 7) or bitmap index data (e.g., bitmap column index data 630 of FIG. 6 and FIG. 7).

In step 9010, a query is received to locate target data in columnar data. In some embodiments, the query comprises a predicate that sets conditions on target data. Using the process in FIG. 8 as an example, the query “select sum(col3) from table1 where col1=‘R’” has a predicate “col1=‘R’,” and the target data is data in column col3 where the value in column col1 is equal to “R.” In some embodiments, the query can be generated from a user of the data analytics storage engine system, or the data analytics storage engine system itself.

In some embodiments, step 9020 can be performed after step 9010. In step 9020, a bitwise operation is performed on one or more values stored in a bitmap data to locate the target data. For example, as shown in FIG. 8, a bitwise operation can be conducted on value “3” stored in the entry to determine the location of data block 841. In some embodiments, the bitmap data comprises a Roaring bitmap.

In step 9030, the target data is located using bitmap data embedded in the splits. In some embodiments, the bitmap data is associated with the columnar data in the splits. In some embodiments, locating the target data is performed by locating a data block that comprises the target data using the bitmap data. The target block is then accessed (e.g., loaded into memory) to locate the target data.

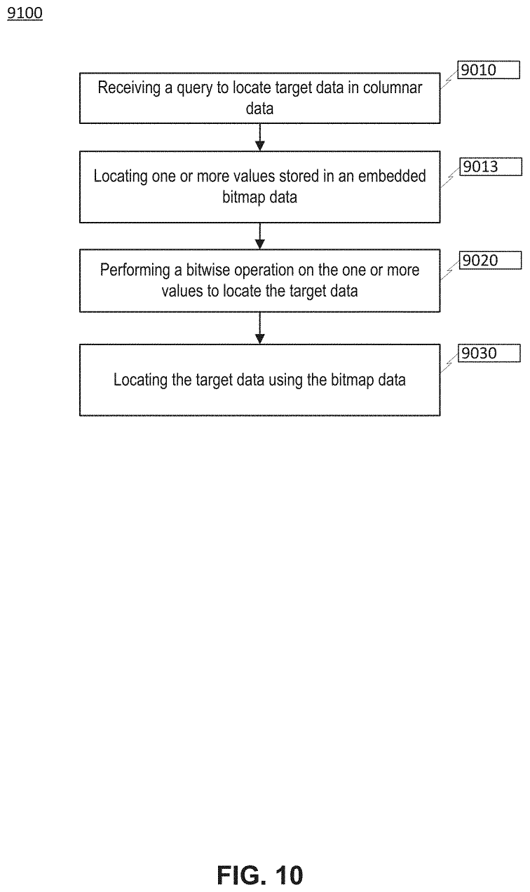

Embodiments of the present disclosure further provide a method to perform a query using embedded bitmap data and dictionary data. FIG. 10 illustrates a flowchart of an exemplary method for executing a query using embedded bitmap data and dictionary data, according to some embodiments of the disclosure. In addition, to steps 9010, 9020, and 9030 shown in FIG. 9, method 9100 in FIG. 10 further comprises step 9013. It is appreciated that method 9100 of FIG. 10 may be performed by a data analytics storage engine system (e.g., data analytics storage engine system 100 of FIG. 4) or a server (e.g., server 110 of FIG. 4). It is also appreciated that method 9100 of FIG. 10 can operate on data analytics storage engines that use embedded bitmap data (e.g., bitmap column chunk data 530 of FIG. 6 and FIG. 7 or bitmap data blocks of col1 830 of FIG. 8) or dictionary data (e.g., dictionary column chunk data 520 of FIG. 7 or dictionary data blocks of col1 820 of FIG. 8).

In step 9013, one or more values stored in the bitmap data are located. The one or more values correspond to the location of the target data in the split. In some embodiments, the dictionary data comprises mapping information for a predicate value in the query and the one or more values. For example, as shown in FIG. 8, blocks in the dictionary data blocks of col1 820 can include mappings between a predicate value (e.g., “R” in column col1) and a corresponding block in the bitmap data blocks of col1 830. More specifically, the third entry in dictionary data blocks of col1 820 can comprise a pointer that points to a corresponding block in the bitmap data blocks of col1 830 (e.g., the third block in bitmap data blocks of col1 830).

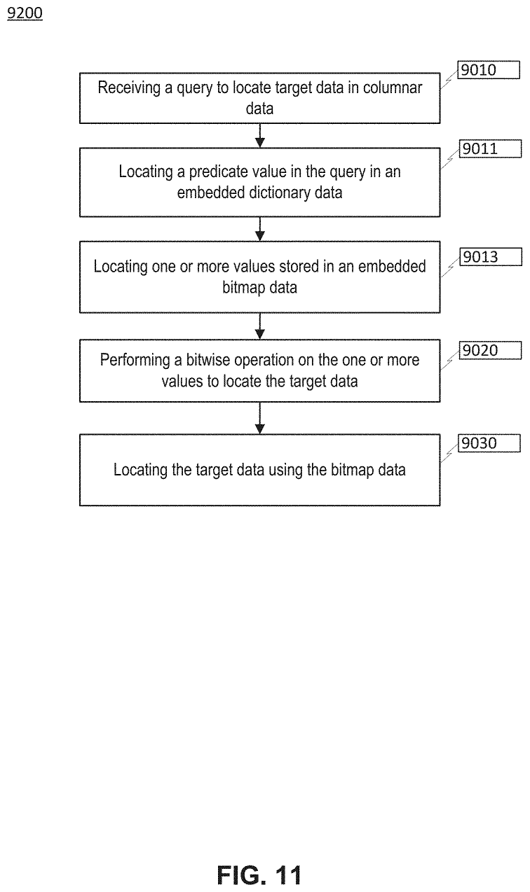

Embodiments of the present disclosure further provides a method to perform a query using embedded bitmap data and dictionary data. FIG. 11 illustrates a flowchart of an exemplary method for executing a query using embedded bitmap data and dictionary data, according to some embodiments of the disclosure. In addition, to steps 9010, 9020, 9030, and 9013 shown in FIG. 9 or FIG. 10, method 9200 in FIG. 11 further comprises step 9011. It is appreciated that method 9200 of FIG. 11 may be performed by a data analytics storage engine system (e.g., data analytics storage engine system 100 of FIG. 4) or a server (e.g., server 110 of FIG. 4). It is also appreciated that method 9200 of FIG. 11 can operate on data analytics storage engines that use embedded bitmap data (e.g., bitmap column chunk data 530 of FIG. 6 and FIG. 7), bitmap index data (e.g., bitmap column index data 630 of FIG. 6 and FIG. 7) or bitmap.

In step 9011, the predicate value in the query is located in the dictionary data using dictionary data. In some embodiments, the dictionary data can be scanned (e.g., sequential scanning or binary search) to locate the predicate value and its corresponding encoding value which can directly map to a bitmap entry in a specific bitmap block and offset in the block.

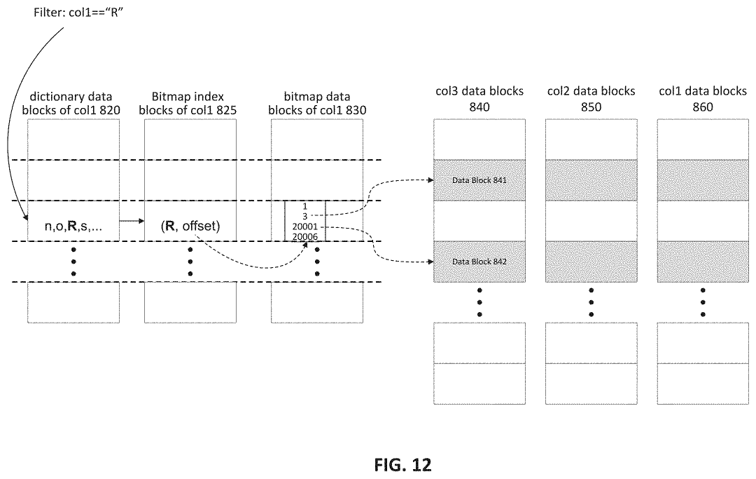

In some embodiments, index for the bitmap data can be used in executing queries. FIG. 12 illustrates an example process to execute a query using embedded dictionary data, bitmap data and bitmap index data, according to some embodiments of the present disclosure. As shown in FIG. 12, on top of the process presented in FIG. 8, there can also be a bitmap index blocks of col1 825. It is appreciated that any query that aims to find specific target data in the data analytics storage engine can be executed using the process shown in FIG. 12. For example, the target data in query “select sum(col3) from table1 where col1=‘R’” is data in column col3 where the value in column 1 is equal to “R.” It is appreciated that the process shown in FIG. 12 can be performed by a data analytics storage engine system (e.g., data analytics storage engine system 100 of FIG. 4) or a server (e.g., server 110 of FIG. 4).

As shown in FIG. 12, when the predicate (e.g., col1=“R”) is found in dictionary data blocks of col1 820, the system can search in bitmap index blocks of col1 825 to find location information for the predicate in the corresponding bitmap data block. For example, as shown in FIG. 12, the system can search bitmap index blocks of col1 825 and find an offset that corresponds to the predicate. Using the offset, the system can easily find the entry in the corresponding bitmap data block (e.g., the third entry in the corresponding bitmap data block). In the example shown in FIG. 12, the entry that includes value “R” has an offset that points to the entry in the bitmap data block that includes values “1,” “3,” “20001,” “20006,” etc. In some embodiments, instead of an offset, the location information stored in bitmap index blocks of col1 825 can comprise a pointer that locates the corresponding entry in the corresponding bitmap data block.

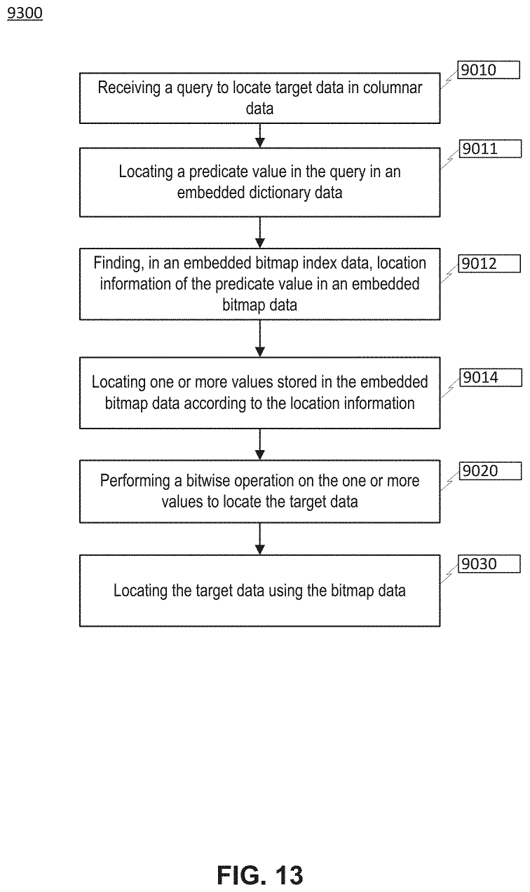

Embodiments of the present disclosure further provides a method to perform a query using embedded bitmap data, dictionary data, and bitmap index. FIG. 13 illustrates a flowchart of an exemplary method for executing a query using embedded bitmap data, dictionary data, and bitmap index, according to some embodiments of the disclosure. In addition, to steps 9010, 9020, 9030, and 9011 shown in FIG. 11, method 9300 in FIG. 13 further comprises step 9012 and 9014. It is appreciated that method 9300 of FIG. 12 may be performed by a data analytics storage engine system (e.g., data analytics storage engine system 100 of FIG. 4) or a server (e.g., server 110 of FIG. 4). It is also appreciated that method 9300 of FIG. 12 can operate on data analytics storage engines that use embedded bitmap data (e.g., bitmap column chunk data 530 of FIG. 6 and FIG. 7), bitmap index data (e.g., bitmap column index data 630 of FIG. 6 and FIG. 7) or bitmap.

In step 9012, an embedded bitmap index data is searched to find location information of the predicate value in an embedded bitmap data. For example, as shown in FIG. 12, the system can search bitmap index blocks of col1 825 and find an offset that correspond to the predicate. Using the offset, the system can easily find the entry in the corresponding bitmap data block (e.g., the third entry in the corresponding bitmap data block). In some embodiments, instead of an offset, the location information stored in the bitmap index data can comprise a pointer that locates the corresponding entry in the corresponding bitmap data.

In step 9014, one or more values stored in the bitmap data are located according to the location information. The one or more values correspond to the location of the target data in the split. For example, as shown in FIG. 11, the location information found in the bitmap index data can be used to locate a corresponding entry in the bitmap data blocks of col1 830.

Embodiments of the present disclosure offer many advantages over traditional designs of data analytics storage engines or database. For example, bitmap indexes incorporated in some embodiments can use bitmaps to answer queries by performing bitmap logical operations on these bitmaps. As a result, the data analytics storage engine can reduce space consumption and logical operation overhead. The Roaring bitmap is also even more efficient. As a result, previous limitation of high cardinality column is resolved.

Moreover, in data analytics storage engine in a cloud environment, columnar data file are generally stored in one or more cloud storage or one or more distributed file systems. In some embodiments, columnar data files have an immutable property, which also applies to the embedded bitmap index. As a result, there is no extra overhead associated specifically with maintaining the bitmap index when update/delete operations are performed. The restrictions for the traditional secondary bitmap index on frequent updated tables is no longer an issue.

In addition, the bitmap index incorporated in some embodiments is beyond a simple min-max index whose effectiveness relies on the corresponding column being in order. The bitmap index is not like a simple bloom filter either, which can return many false-positive results to queries. The bitmap index incorporated in some embodiments can provide exact locations where the key is stored. As a result, embedded bitmap index can be used to compensate min-max index for efficient scan and provide significant efficiency in storage and performance.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. It is understood that multiple ones of the above described modules/units may be combined as one module/unit, and each of the above described modules/units may be further divided into a plurality of sub-modules/sub-units.

The embodiments may further be described using the following clauses:

1. A method for executing a query in a data analytics storage engine, the method comprising:

receiving a query to locate target data in the data analytics storage engine that comprises:
rows of data divided into one or more splits of data having columns of data that correspond to the rows of data, and
bitmap data embedded in the one or more splits, wherein the bitmap data is associated with the columns of data; and

locating the target data using the bitmap data in the one or more splits.

2. The method of clause 1, wherein locating the target data using the bitmap data in the one or more splits further comprising:

performing a bitwise operation on one or more values stored in the bitmap data to locate the target data.

3. The method of clause 2, wherein:

the data analytics storage engine further comprises bitmap index data embedded in the one or more splits, wherein the bitmap index data is associated with the bitmap data embedded in the one or more splits; and

locating the target data using the bitmap data in the one or more splits further comprises:
locating the one or more values stored in the bitmap data using the bitmap index data.

4. The method of any one of clauses 1-3, wherein:

the columns of data in the one or more splits are divided into data blocks; and

locating the target data using the bitmap data in the one or more splits further comprises:
locating a data block that comprises the target data using the bitmap data; and
accessing the data block.

5. The method of any one of clauses 2-4, wherein:

the data analytics storage engine further comprises dictionary data embedded in the one or more splits, wherein the dictionary data is associated with the columns of data; and

locating the target data using the bitmap data in the one or more splits further comprises:
locating the one or more values stored in the bitmap data using dictionary data.

6. The method of clause 5, wherein:

the dictionary data comprises mapping information for a predicate value in the query and the one or more values; and

locating the one or more values stored in the bitmap data using dictionary data further comprises:
locating the one or more values stored in the bitmap data according to the mapping information.

7. The method of any one of clauses 1-6, wherein:

the bitmap data is a Roaring bitmap.

8. A data analytics storage engine system, comprising:

rows of data divided into one or more splits of data having columns of data that correspond to the rows of data, and

bitmap data embedded in the one or more splits, wherein the bitmap data is associated with the columns of data and the bitmap data is configured to locate, in the one or more splits, target data in a query.

9. The data analytics storage engine system of clause 8, wherein bitmap data is further configured to:

have a bitwise operation performed on one or more values stored in the bitmap data to locate the target data.

10. The data analytics storage engine system of clause 9, wherein:

the data analytics storage engine system further comprises bitmap index data embedded in the one or more splits, wherein the bitmap index data is associated with the bitmap data embedded in the one or more splits; and

the bitmap index data is configured to:
locate the one or more values stored in the bitmap data.

11. The data analytics storage engine system of any one of clauses 8-10, wherein:

the columns of data in the one or more splits are divided into data blocks; and

the bitmap data is further configured to:
locate a data block that comprises the target data.

12. The data analytics storage engine system of any one of clauses 9-11, wherein:

the data analytics storage engine system further comprises dictionary data embedded in the one or more splits, wherein the dictionary data is associated with the columns of data; and

the dictionary data is configured to:
locate the one or more values stored in the bitmap data using dictionary data.

13. The data analytics storage engine system of clause 12, wherein:

the dictionary data comprises mapping information for a predicate value in the query and the one or more values; and

the dictionary data is further configured to:
locate the one or more values stored in the bitmap data according to the mapping information.

14. The data analytics storage engine system of any one of clauses 8-13, wherein:

the bitmap data is a Roaring bitmap.

15. A non-transitory computer readable medium that stores a set of instructions that is executable by one or more processors of a data analytics storage engine to cause the data analytics storage engine to initiate a method comprising:

receiving a query to locate target data in the data analytics storage engine that comprises:
rows of data divided into one or more splits of data having columns of data that correspond to the rows of data, and
bitmap data embedded in the one or more splits, wherein the bitmap data is associated with the columns of data; and

locating the target data using the bitmap data in the one or more splits.

16. The non-transitory computer readable medium of clause 15, wherein locating the target data using the bitmap data in the one or more splits further comprising:

performing a bitwise operation on one or more values stored in the bitmap data to locate the target data.

17. The non-transitory computer readable medium of clause 16, wherein:

the data analytics storage engine further comprises bitmap index data embedded in the one or more splits, wherein the bitmap index data is associated with the bitmap data embedded in the one or more splits; and

the method further comprises:
locating the one or more values stored in the bitmap data using the bitmap index data.

18. The non-transitory computer readable medium of any one of clauses 15-17, wherein:

the columns of data in the one or more splits are divided into data blocks; and

the method further comprises:
locating a data block that comprises the target data using the bitmap data; and
accessing the data block.

19. The non-transitory computer readable medium of any one of clauses 16-18, wherein:

the data analytics storage engine further comprises dictionary data embedded in the one or more splits, wherein the dictionary data is associated with the columns of data; and

the method further comprises:
locating the one or more values stored in the bitmap data using dictionary data.

20. The non-transitory computer readable medium of clause 19, wherein:

the dictionary data comprises mapping information for a predicate value in the query and the one or more values; and

the method further comprises:
locating the one or more values stored in the bitmap data according to the mapping information.

21. The non-transitory computer readable medium of any one of clauses 15-20, wherein:

the bitmap data is a Roaring bitmap.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

Unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method. In the drawings and specification, there have been disclosed exemplary embodiments. However, many variations and modifications can be made to these embodiments. Accordingly, although specific terms are employed, they are used in a generic and descriptive sense only and not for purposes of limitation, the scope of the embodiments being defined by the following claims.

What is claimed is:

1. A method for executing a query in a data analytics storage engine, the method comprising:
receiving a query to locate target data in the data analytics storage engine that comprises:
rows of data divided into one or more splits of data having columns of data that correspond to the rows of data, and
bitmap data embedded in the one or more splits, wherein the bitmap data is associated with the columns of data; and
locating the target data using the bitmap data in the one or more splits.

2. The method of claim 1, wherein locating the target data using the bitmap data in the one or more splits further comprising:
performing a bitwise operation on one or more values stored in the bitmap data to locate the target data.

3. The method of claim 2, wherein:
the data analytics storage engine further comprises bitmap index data embedded in the one or more splits, wherein the bitmap index data is associated with the bitmap data embedded in the one or more splits; and
locating the target data using the bitmap data in the one or more splits further comprises:
locating the one or more values stored in the bitmap data using the bitmap index data.

4. The method of claim 1 wherein:
the columns of data in the one or more splits are divided into data blocks; and
locating the target data using the bitmap data in the one or more splits further comprises:
locating a data block that comprises the target data using the bitmap data; and
accessing the data block.

5. The method of claim 2, wherein:
the data analytics storage engine further comprises dictionary data embedded in the one or more splits, wherein the dictionary data is associated with the columns of data; and
locating the target data using the bitmap data in the one or more splits further comprises:
locating the one or more values stored in the bitmap data using dictionary data.

6. The method of claim 5, wherein:
the dictionary data comprises mapping information for a predicate value in the query and the one or more values; and
locating the one or more values stored in the bitmap data using dictionary data further comprises:
locating the one or more values stored in the bitmap data according to the mapping information.

7. The method of claim 1, wherein:
the bitmap data is a Roaring bitmap.

8. A data analytics storage engine system, comprising:
rows of data divided into one or more splits of data having columns of data that correspond to the rows of data, and
bitmap data embedded in the one or more splits, wherein the bitmap data is associated with the columns of data and the bitmap data is configured to locate, in the one or more splits, target data in a query.

9. The data analytics storage engine system of claim 8, wherein bitmap data is further configured to:
have a bitwise operation performed on one or more values stored in the bitmap data to locate the target data.

10. The data analytics storage engine system of claim 9, wherein:
the data analytics storage engine system further comprises bitmap index data embedded in the one or more splits, wherein the bitmap index data is associated with the bitmap data embedded in the one or more splits; and
the bitmap index data is configured to:
locate the one or more values stored in the bitmap data.

11. The data analytics storage engine system of claim 10, wherein:
the columns of data in the one or more splits are divided into data blocks; and
the bitmap data is further configured to
locate a data block that comprises the target data.

12. The data analytics storage engine system of claim 9, wherein:
the data analytics storage engine system further comprises dictionary data embedded in the one or more splits, wherein the dictionary data is associated with the columns of data; and
the dictionary data is configured to:
locate the one or more values stored in the bitmap data using dictionary data.

13. The data analytics storage engine system of claim 12, wherein:
the dictionary data comprises mapping information for a predicate value in the query and the one or more values; and
the dictionary data is further configured to:
locate the one or more values stored in the bitmap data according to the mapping information.

14. The data analytics storage engine system of claim 8, wherein:
the bitmap data is a Roaring bitmap.

15. A non-transitory computer readable medium that stores a set of instructions that is executable by one or more processors of a data analytics storage engine to cause the data analytics storage engine to initiate a method comprising:
receiving a query to locate target data in the data analytics storage engine that comprises:
rows of data divided into one or more splits of data having columns of data that correspond to the rows of data, and
bitmap data embedded in the one or more splits, wherein the bitmap data is associated with the columns of data; and
locating the target data using the bitmap data in the one or more splits.

16. The non-transitory computer readable medium of claim 15, wherein locating the target data using the bitmap data in the one or more splits further comprising:
performing a bitwise operation on one or more values stored in the bitmap data to locate the target data.

17. The non-transitory computer readable medium of claim 16, wherein:
the data analytics storage engine further comprises bitmap index data embedded in the one or more splits, wherein the bitmap index data is associated with the bitmap data embedded in the one or more splits; and
the method further comprises:
locating the one or more values stored in the bitmap data using the bitmap index data.

18. The non-transitory computer readable medium of claim 15, wherein:
the columns of data in the one or more splits are divided into data blocks; and
the method further comprises:
locating a data block that comprises the target data using the bitmap data; and
accessing the data block.

19. The non-transitory computer readable medium of claim 16, wherein:
the data analytics storage engine further comprises dictionary data embedded in the one or more splits, wherein the dictionary data is associated with the columns of data; and
the method further comprises:
locating the one or more values stored in the bitmap data using dictionary data.

20. The non-transitory computer readable medium of claim 19, wherein:
the dictionary data comprises mapping information for a predicate value in the query and the one or more values; and
the method further comprises:
locating the one or more values stored in the bitmap data according to the mapping information.

21. The non-transitory computer readable medium of claim 15, wherein:
the bitmap data is a Roaring bitmap.
